(19) United States
(12) Patent Application Publication
(10) Pub. No.: US 2025/0245615 A1
(43) Pub. Date: Jul. 31, 2025

(54) SPATIAL PARTITIONING OF A CROSS-DOCK TRANSPORTATION NETWORK

(71) Applicant: Walmart Apollo, LLC, Bentonville, AR (US)

(72) Inventors: Liqing Zhang, Humble, TX (US); Ming Ni, Pflugerville, TX (US); Nadere Mansouri, McKinney, TX (US); Rohan Prakash, Rogers, AR (US); Li Ji, Fremont, CA (US); Ti Zhang, Rocklin, CA (US); Jing Huang, San Jose, CA (US); Mingang Fu, Palo Alto, CA (US); Kunlei Lian, Windermere, FL (US)

(73) Assignee: Walmart Apollo, LLC, Bentonville, AR (US)

(21) Appl. No.: 19/042,466

(22) Filed: Jan. 31, 2025

Related U.S. Application Data
(60) Provisional application No. 63/627,615, filed on Jan. 31, 2024.

(51) Int. Cl. G06Q 10/0835

(52) U.S. Cl. CPC G06Q 10/08355

(57) ABSTRACT

A system including a processor and a non-transitory computer-readable media storing computing instructions that, when executed on the processor, cause the processor to perform certain operations: obtaining a distribution of transit miles for inbound loads located within a distance of each facility of multiple facilities; creating, using a partition engine, multiple spatial partitions within the distance of each facility of the multiple facilities; determining, using the partition engine, a multi-partition distance by combining multiple spatial partitions with overlapping distances; determining shipment consolidation options for the inbound loads within the multi-partition distance of the multiple facilities; and generating a transit plan corresponding to the inbound loads located within the multi-partition distance, based on the shipment consolidation options. Other embodiments are described.

### CROSS-REFERENCE TO RELATED APPLICATION

This application claims the benefit of U.S. Provisional Application No. 63/627,615, filed Jan. 31, 2024, which is incorporated herein by reference in its entirety.

### TECHNICAL FIELD

This disclosure relates generally to spatial partitioning of a cross-dock transportation network.

### BACKGROUND

An inbound transportation network can include various facilities, such as vendors, distribution centers, center points, etc. The configuration of loads that are shipped within the transportation network, and the routes used for such loads, can affect the overall efficiency and costs of the inbound transportation network.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system for performing spatial partitioning of a cross-dock transportation network;

FIG. 4 illustrates a flow chart for handling optimization request through a coordination engine;

FIG. 5 illustrates a flow chart for a method of performing spatial partitioning of a cross-dock transportation network, according to another embodiment;

FIG. 6 illustrates an example of the distribution of vendor locations, DC locations, and CP location where the majority of vendor locations are densely clustered in the eastern region and the mid-east region of the United States;

FIG. 7 shows how two spatial partitions can overlap each other as illustrated by partition CP1 and partition CP2;

FIG. 8 shows how a multi-partition is created by combining two multiple spatial partitions such as combining CP1 with CP2 where the overlap between the two individual spatial partitions is covered as part of the multi-partition; and

FIG. 9 shows how long distance shipments can span a longer transit time via a route and load plan as the route and load plan excluded a CP Center stop as a destination.

### DETAILED DESCRIPTION

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

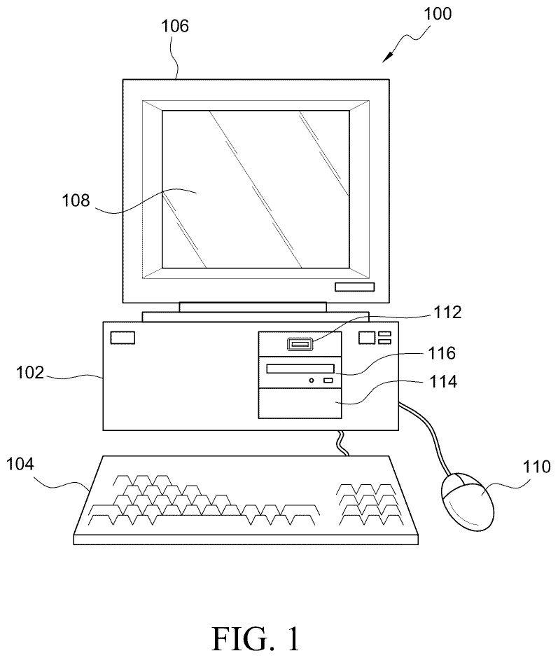

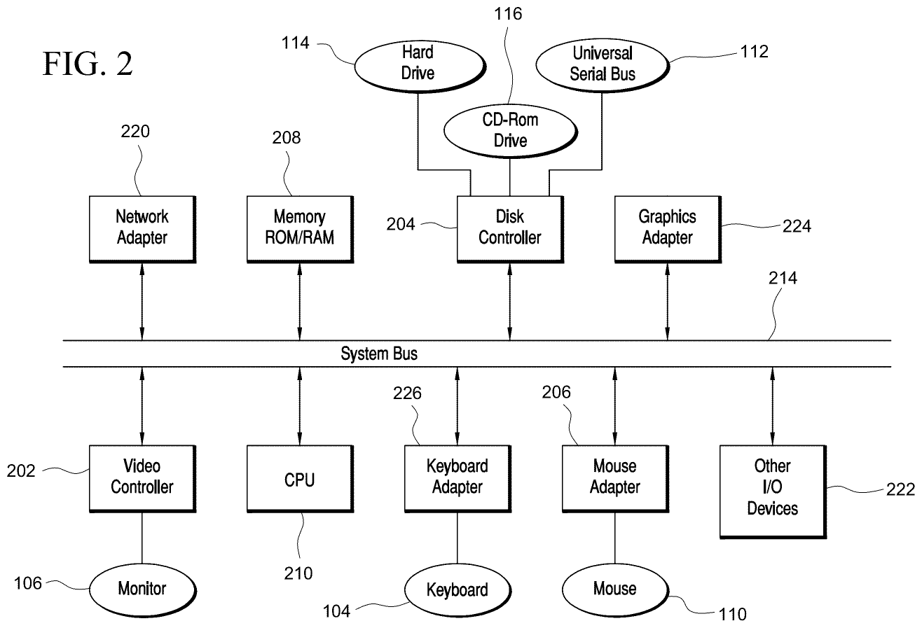

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative activity diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

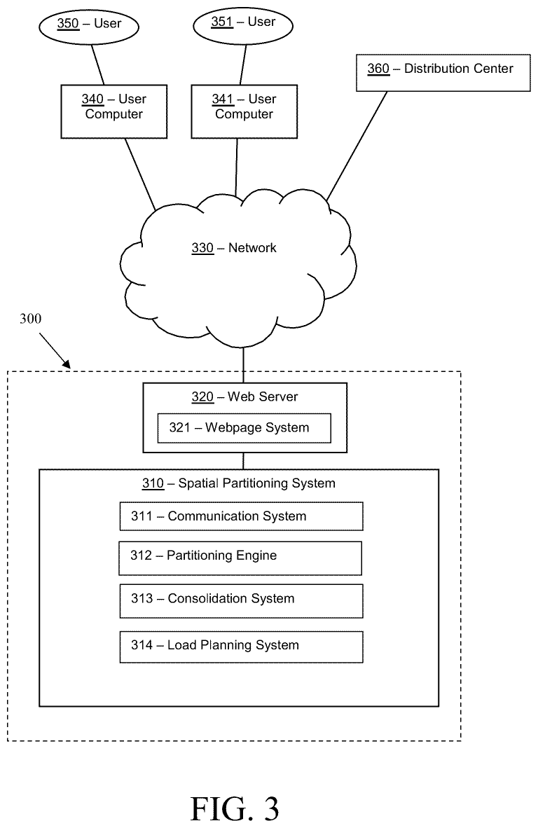

Turning ahead in the drawings, FIG. 3 illustrates a block diagram of a system 300 for performing spatial partitioning of a cross-dock transportation network. System 300 is merely exemplary, and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. System 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In many embodiments, system 300 can include a spatial partitioning system 310 and/or a web server 320. Spatial partitioning system 310 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host two or more of, or all of, spatial partitioning system 310 and/or web server 320. Additional details regarding spatial partitioning system 310 and/or web server 320 are described herein.

In a number of embodiments, each system of spatial partitioning system 310 and/or web server 320 can be a special-purpose computer programed specifically to perform specific functions not associated with a general-purpose computer, as described in greater detail below.

In some embodiments, web server 320 can be in data communication through a network 330 with one or more user computers, such as user computers 340 and/or 341. Network 330 can be a public network, a private network, or a hybrid network. In some embodiments, user computers 340-341 can be used by users, such as users 350 and 351, which also can be referred to as customers, in which case, user computers 340 and 341 can be referred to as customer computers. In many embodiments, web server 320 can host one or more sites (e.g., websites) that allow users to interface with spatial partitioning system 310, such as to generate multiple spatial partitions within a distance from a facility (e.g., a center point center (CP) or a distribution center (DC), and to generate a multi-partition distance to enable consolidation of shipments and) and to reduce transportation costs across a cross-dock retail transportation network, in addition to other suitable activities.

In some embodiments, an internal network that is not open to the public can be used for communications between spatial partitioning system 310 and/or web server 320 within system 300. Accordingly, in some embodiments, spatial partitioning system 310 (and/or the software used by such systems) can refer to a back end of system 300, which can be operated by an operator and/or administrator of system 300, and web server 320 (and/or the software used by such system) can refer to a front end of system 300, and can be accessed and/or used by one or more users, such as users 350-351, using user computers 340-341, respectively. In these or other embodiments, the operator and/or administrator of system 300 can manage system 300, the processor(s) of system 300, and/or the memory storage unit(s) of system 300 using the input device(s) and/or display device(s) of system 300.

In certain embodiments, user computers 340-341 can be desktop computers, laptop computers, a mobile device, and/or other endpoint devices used by one or more users 350 and 351, respectively. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Palm® operating system by Palm, Inc. of Sunnyvale, California, United States, (iv) the Android™ operating system developed by the Open Handset Alliance, (v) the Windows Mobile™ operating system by Microsoft Corp. of Redmond, Washington, United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can include a mobile device, and vice versa. However, a wearable user computer device does not necessarily include a mobile device, and vice versa.

In specific examples, a wearable user computer device can include a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can include (i) Google Glass™ product or a similar product by Google Inc. of Menlo Park, California, United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, New York, United States of America. In other specific examples, a head mountable wearable user computer device can include the Virtual Retinal Display™ product, or similar product by the University of Washington of Seattle, Washington, United States of America. Meanwhile, in further specific examples, a limb mountable wearable user computer device can include the iWatch™ product, or similar product by Apple Inc. of Cupertino, California, United States of America, the Galaxy Gear or similar product of Samsung Group of Samsung Town, Seoul, South Korea, the Moto 360 product or similar product of Motorola of Schaumburg, Illinois, United States of America, and/or the Zip™ product, One™ product, Flex™ product, Charge™ product, Surge™ product, or similar product by Fitbit Inc. of San Francisco, California, United States of America.

In some embodiments, system 300 can be a distributed system that includes one or more systems in each of the distribution centers (e.g., 360). In several embodiments, distribution centers can include CP centers, and/or another suitable facility. In other embodiments, system 300 can be a centralized system that communicates with computer systems in the distribution centers (e.g., 360). In some embodiments, network 330 can be an internal network that is not open to the public, which can be used for communications between system 300, and distribution centers (e.g., 360). In other embodiments, network 330 can be a public network, such as the Internet. In several embodiments, operators and/or administrators of system 300 can manage system 300, the processor(s) of system 300, and/or the memory storage unit(s) of system 300 using the input device(s) and/or display device(s) of system 300, or portions thereof in each case.

In several embodiments, system 300 can include one or more input devices (e.g., one or more keyboards, one or more keypads, one or more pointing devices such as a computer mouse or computer mice, one or more touchscreen displays, a microphone, etc.), and/or can each include one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to system 300 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of system 300. In a similar manner, the processors and/or the non-transitory computer-readable media can be local and/or remote to each other.

Meanwhile, in many embodiments, system 300 also can be configured to communicate with and/or include one or more databases. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communication between system 300, network 330, distribution center 360, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, spatial partitioning system 310 can include a communication system 311, a partitioning system 312, a consolidation system 313, and/or a load planning system 314. In many embodiments, the systems of spatial partitioning system 310 can be modules of computing instructions (e.g., software modules) stored at non-transitory computer readable media that operate on one or more processors. In other embodiments, the systems of spatial partitioning system 310 can be implemented in hardware. Spatial partitioning system 310 can be a computer system, such as computer system 100 (FIG. 1), as described above, and can be a single computer, a single server, or a cluster or collection of computers or servers, or a cloud of computers or servers. In another embodiment, a single computer system can host spatial partitioning system 310. Additional details regarding spatial partitioning system 310 and the components thereof are described herein.

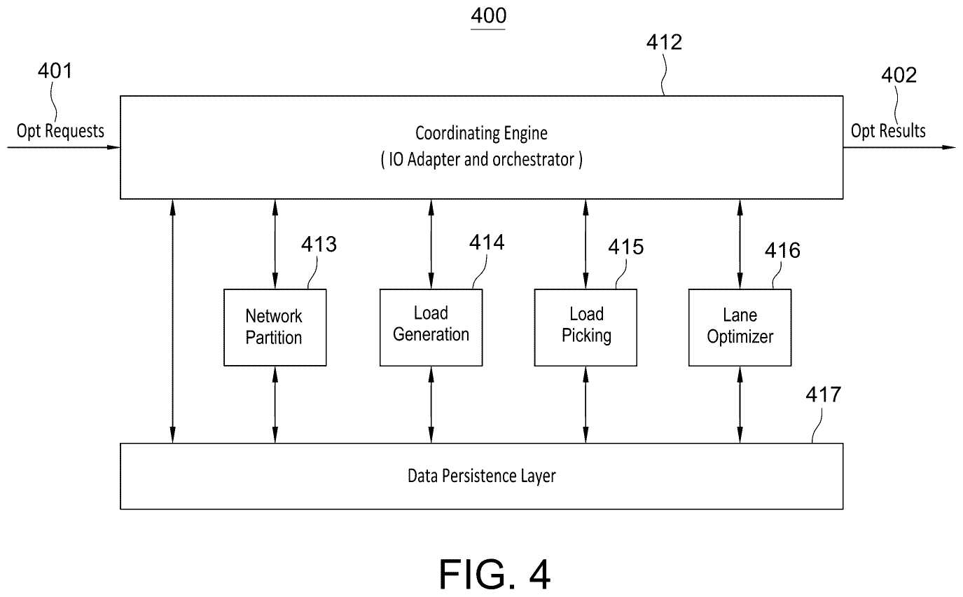

Turning ahead in the drawings, FIG. 4 illustrates a block diagram of an architecture 400 of engines 412-416 and data persistence layer 417 for spatial partitioning system 310 (FIG. 3). Architecture 400 is merely exemplary, and embodiments of spatial partitioning system 310 (FIG. 3) are not limited to architecture 400 presented herein.

As shown in FIG. 4, a central coordinating engine, such as coordinating engine 412, can be an input/output (IO) adapter and orchestrator among the functional engines (e.g., engines 412-416), so that the functional engines can be triggered to process subproblems of an optimization problem for selecting candidate loads. Each functional engine can be triggered a single time or multiple times, and/or can run multiple instances in parallel to solve respective subproblems of the optimization problem directly. In several embodiments, engines 412-416 can interface with data persistence layer 417 to access and/or store data. In many embodiments, data can be stored in data persistence layer 417 between engines. In many embodiments, architecture 400 can make use of cloud computing a parallel processing.

In several embodiments, coordinating engine 412 can receive inputs (e.g., optimization requests 401), output optimization results 402 (e.g., outputs), and/or orchestrate the overall optimization process. In a number of embodiments, coordinating engine 412 can keep track of engine status, such as ready, busy, complete, or failed, of the engines. In other embodiments, communication system 311 (FIG. 3) can be used for IO with spatial partitioning system 310 (FIG. 3).

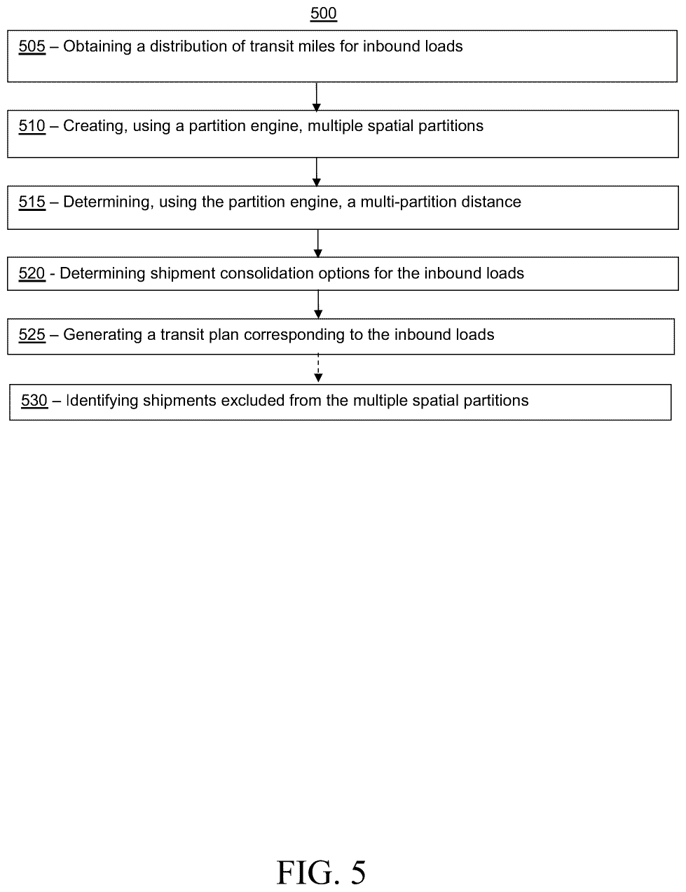

In several embodiments, network partition engine 413 can divide the inbound network (e.g., 500 (FIG. 5)) into several smaller subnetworks to be solved independently by load generation engine 414. In many embodiments, the partitioning scheme used by network partition engine 413 can be data driven.

In several embodiments, load generation engine 414 can generate candidate loads, such as feasible loads and/or loads that meet a threshold level of quality for the subnetworks. For example, shipments can be consolidated as candidate loads. In many embodiments, coordinating engine 412 can trigger multiple instances of load generation engine 414, and each instance of load generation engine 414 can solve a different subnetwork, as generated by network partition engine 413. The number of instances of load generation engine 414 can be scaled on-demand to the number of subnetworks. These instances of the load generation engine 414 can be implemented by distributed process, such as parallel processing across parallel processors. The activities of load generation engine can be similar or identical to U.S. patent application Ser. No. 17/589,030, filed Jan. 31, 2022, titled Load Builder Optimizer Using a Column Generation Engine, which is hereby incorporated by reference in its entirety.

In several embodiments, load picking engine 415 can select the final set of loads to be used from among the combined pool of candidate loads generated from the multiple instances of load generation engine 414. For example, loads can be consolidated across the entire network, and loads can be selected to minimize overall transportation costs. In a number of embodiments, load picking engine 415 can select the final set of loads as shown in method 500 (FIG. 5, described below) In several embodiments, lane optimizer engine 416 can evaluate alternative carriers applicable to each load selected by load picking engine 415, and can select the most suitable carrier based on business lane constraints for each load.

In many embodiments, data persistence layer 417 can facilitate data sharing to limit data requests between engines and/or limit duplicated requests. In many embodiments, engines can be scaled horizontally for parallel computing, as needed, including across the different types of engines. In many embodiments, the status of an engine can be saved, and the status can be rehydrated, such as copying the same steps from the previous run, such that rerunning of steps can be limited to fails, changes, or updates.

In many embodiments, architecture 400 can solve large-scale optimization problems, and can support solving such optimization problems on the largest transportation networks in the world. In many embodiments, architecture can be implemented with cloud computing, which can leverage automated cloud deployment solutions, such as Kubernetes (which was originally authored by Google, and is now provided by the Cloud Native Computing Foundation), to scale demand. The cloud infrastructure can be utilized to accelerate problem solving in the form of parallel computing.

Many conventional freight planning systems struggle to scale. For example, in some conventional systems, load templates are created, and shipments are assigned to the load templates. The load template creation often limits the possible choices. As another example, in some conventional systems, a strategy is generated to sequence different consolidation behaviors, and shipments are filtered with preconfigured characteristics for each consolidation behavior, which is then collected and compared, which involves extensive user involvement to monitor and handle new or changing scenarios and to add consolidation behavior accordingly to reflect the changed scenario. Both issues involve running steps sequentially, which limits its ability to be deployed in, and take advantage of, a parallel computing or distributed cloud environment.

In many embodiments, the techniques described herein can provide a modularized algorithm scheme to enable combination and reuse of algorithms, which also can be customized for different business units. For example, each of the functional engines (e.g., 412-416) of spatial partitioning system 310 can use a modularized algorithm scheme to combine and reuse algorithmic solvers. In many embodiments, the algorithmic solvers can be scaled vertically and/or horizontally.

Turning ahead in the drawings, FIG. 5 illustrates a flow chart for a method 500, according to another embodiment. In some embodiments, method 500 can be a method of performing spatial partitioning of a cross-dock transportation network. Method 500 is merely exemplary and is not limited to the embodiments presented herein. Method 500 can be employed in many different embodiments and/or examples not specifically depicted or described herein. In some embodiments, the procedures, the processes, and/or the activities of method 500 can be performed in the order presented. In other embodiments, the procedures, the processes, and/or the activities of method 500 can be performed in any suitable order. In still other embodiments, one or more of the procedures, the processes, and/or the activities of method 500 can be combined or skipped. In several embodiments, system 300 (FIG. 3) can be suitable to perform method 500 and/or one or more of the activities of method 500.

In these or other embodiments, one or more of the activities of method 500 can be implemented as one or more computing instructions configured to run at one or more processors and configured to be stored at one or more non-transitory computer-readable media. Such non-transitory computer-readable media can be part of a computer system such as spatial partitioning system 310 and/or web server 320. The processor(s) can be similar or identical to the processor(s) described above with respect to computer system 100 (FIG. 1).

In several embodiments, FIG. 5 can include an activity 505 of obtaining a distribution of transit miles for inbound loads located within a distance of each facility of multiple facilities. In some embodiments, transporting inbound loads can be part of a larger cross-dock inbound transportation network that connects vendor locations with multiple facility locations, such as DC centers and/or CP centers. In some embodiments, obtaining a distribution of transit miles can include transit miles for route and load plans that start at pickup vendor locations to CP centers, pickup vendor locations to DC centers, pick up CP centers to DC centers, and/or another suitable route and load.

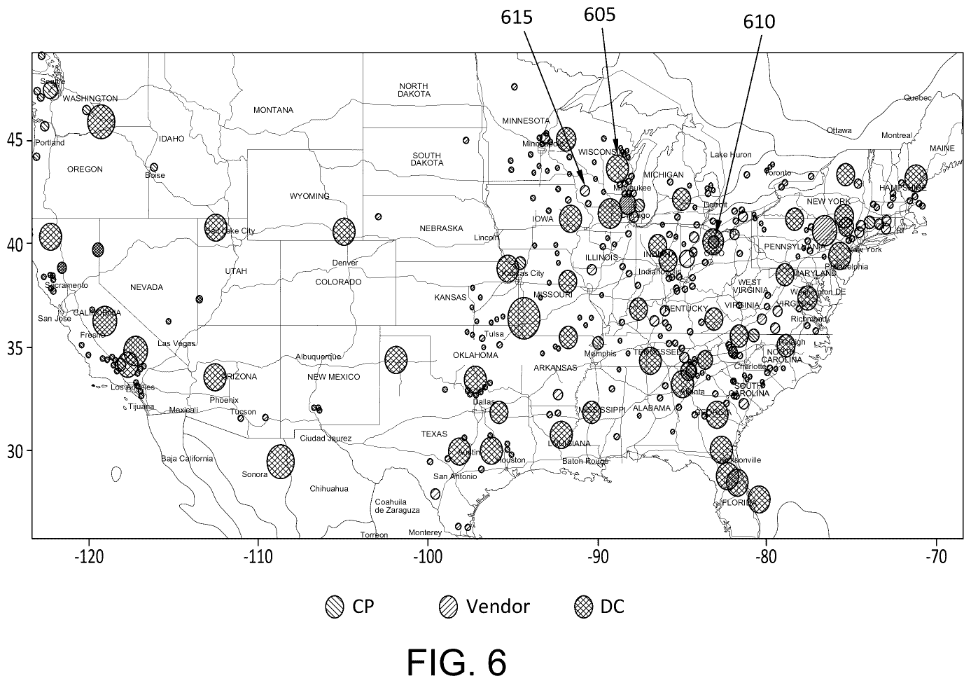

In some embodiments, obtaining the distribution of transit miles for the inbound loads can be based on at least one of (i) vendor locations in proximity to facility locations or (ii) a list of states in which the facility locations are located. In several embodiments, while there are approximately 50 DC centers facilities located across the United State, the majority of the DC centers are proximately located nearest to the largest density of vendor locations in the eastern region and mid-east region of the country. In some embodiments, there are approximated a 10 CP centers also proximately located within the largest density of vendor locations, however the CP centers can provide interim destination functions, such as a temporary holding facilities where shipments can be unloaded based on facility constraints and act as an interim final delivery destination as part of a multi-model transportation route and load plan. FIG. 6 illustrates an example of the distribution of vendor locations 615, DC locations 605, and CP location 610 where the majority of vendor locations are densely clustered in the eastern region and the mid-east region of the United States.

In several embodiments, obtaining the distribution of transit miles can include finding a relationship between a state where the vendor is located proximate to more than one nearest CP location, which can involve interstate transportation over state lines that may include transportation constraints in a route and load plan crossing state boundaries.

In various embodiments, FIG. 5 can include an activity 510 of creating, using a partition engine, multiple spatial partitions within the distance of each facility of the multiple facilities. In several embodiments, the partition algorithm can include five steps: Step 1. Analyze historical inbound loads to identify a base region of vendors for each CP facility; Step 2. Use the base region from Step 1 to create single-CP partitions. For example, when there are 10 CPs, Step 2 can create approximately 10 partitions that can have overlapping regions. Step 3. Join multiple nearby single-CP partitions together to generate multi-CP partitions in order to capture potential transportation cost savings otherwise lost with single-CP partitions. User can define the max number of CPs in multi-CP partitions. Step 4. Add allowance exceptions. Step 4 can consider shipments with a long transit time between a vendor to a DC and allow new transit options by re-redirecting routes to CPs that can be closer to the DC. Step 5. Add complement DC partitions. Step 5 can generate other partitions for shipments that are not covered by any single partition and/or multi-partitions to a CP.

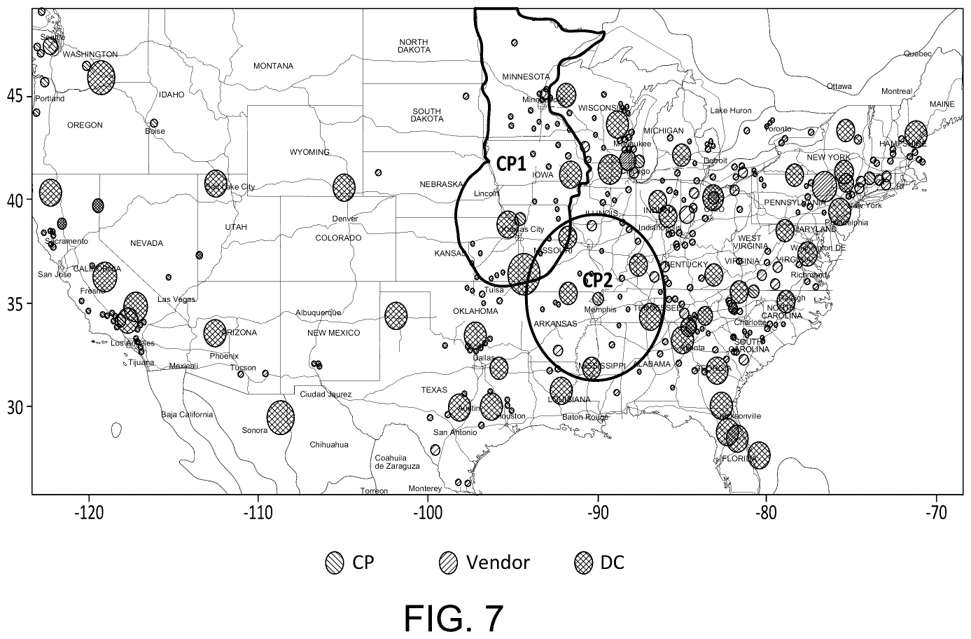

In some embodiments, creating the multiple spatial partitions can include identifying a base region for a facility of the multiple facilities. In various embodiments, identifying the base region can include determining an expandable radius of the base region to capture an area of a target coverage percentage for the facility. In several embodiments, each single spatial partition of the multiple spatial partitions can include a region of overlap between two spatial partitions. In some embodiments, the overlap can cross state boundaries that can be part of a route and load plan for a shipment being transported from a vendor location to a CP location. FIG. 7 shows how two spatial partitions can overlap each other as illustrated by partition CP1 and partition CP2. In several embodiments, two spatial partitions with overlap can qualify to be merged or joined as a multi-partition distance.

In various embodiments, the target coverage percentage is a percentage that is less than or equal to a number of historical loads within the base region at the facility divided by a number of total historical loads for the facility. In some embodiments, analyzing historical CP loads can include creating a short list of states that are within a distance of the vendor locations and CP locations for use in calculating a target coverage percentage metric.

In some embodiments, the covered historical loads comprise historical loads for which a vendor location is either (i) within the expandable radius of a first distance to the facility, or (ii) located in a list of states covered by the vendor location of the facility.

In various embodiments, when the percentage is less than the target covered percentage, expanding the expandable radius of the first distance to the facility or adding another state to the list of states.

In some embodiments, determining the shipment consolidation options can include adding a shipment to the inbound loads when (i) a direct transit mileage from the vendor location to the facility exceeds a predetermined threshold or (ii) a direct transit has a low vehicle fill rate. In several embodiments, activity 510 can include consolidating multiple shipments to the inbound load to generate an overall lower transportation cost.

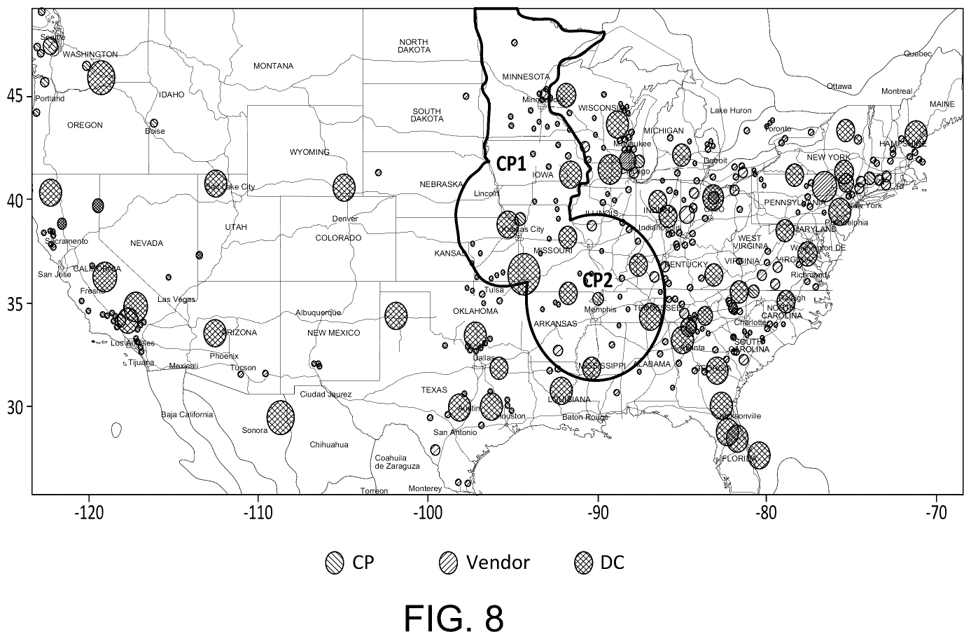

In several embodiments, FIG. 5 also can include an activity 515 of determining, using the partition engine, a multi-partition distance by combining multiple spatial partitions with overlapping distances. An advantage of joining multiple spatial partitions can include decreasing transportation costs by expanding the region for pickup and delivery to CP centers that otherwise would not have been part of a route and load plan. FIG. 8 shows how a multi-partition is created by combining two multiple spatial partitions such as combining CP1 with CP2 where the overlap between the two individual spatial partitions is covered as part of the multi-partition.

In some embodiments, FIG. 5 further can include an activity 520 of determining shipment consolidation options for the inbound loads within the multi-partition distance of the multiple facilities. In several embodiments, activity 520 further can include providing more shipment consolidation options for the inbound loads within the multi-partition distance of the multiple facilities. In various embodiments, an advantage of merging or joining multiple single-CP partitions is expanding the shipment consolidation options for inbound loads including additional options for vendors that are located in regions geographically close to other CPs. In several embodiments, since the base region can be based upon a pre-defined target coverage percentage, a small number of vendors located outside of the base region can be excluded from using a single-CP partition. Another advantage of using the multi-CP partition can include providing such vendors opportunities to use a CP facility other than its nearest CP that were otherwise excluded. In many embodiments, load and route plans for carriers can include multi-pickup locations at multiple vendor locations. As an example, a single route can include a pick-up at vendor 1 and drive to vendor 2 for additional pickup and then deliver to final destinations. In various embodiments, when creating multi-CP partitions, activity 520 can include providing options for vendors that are not grouped together in any single-CP partition to consolidate vendor shipments together as a multi-pickup load. In some embodiments, when vendors consolidate vendor shipments, the number of additional options to select lower cost solutions can increase.

In many embodiments, FIG. 5 additionally can include an activity 525 of generating a transit plan corresponding to the inbound loads located within the multi-partition distance, based on the shipment consolidation options. In some embodiments, generating a transit plan can include generating a route and load plan based on (i) the multi-partition distances or (ii) the number of vendor shipments consolidated for a multi-pick up load.

In various embodiments, activity 525 can include incorporating allowance of exceptions for shipments that can benefit from using CPs whose base regions do not cover the pickup location for a shipment. As an example, CP locations are less densely located in the western region of the U.S., thus without allowance of exceptions, vendors located on the western region can have limited CP options. If the delivery location of the shipment is located on the eastern region, then the shipment can be routed for a short inbound transit and a long outbound transit. An advantage of adding a shipment to a partition of a CP located in the middle region can include allowing the shipment to be on a carrier with longer inbound transit times and shorter outbound transit times, which can have a lower total transportation cost and/or transit time.

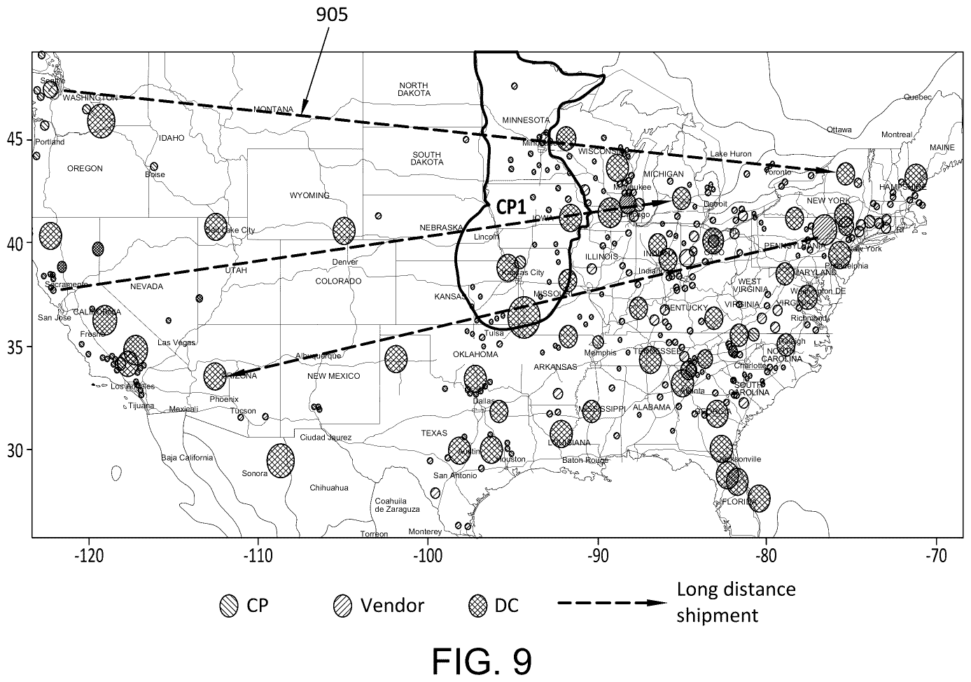

FIG. 9 shows how long distance shipments can span a longer transit time via a route and load plan 905 as the route and load plan excluded a CP Center stop as a destination. As an example, route and load plan 905 is primed to start at a vendor location in Washington State as a long distance shipment then to be delivered to a DC center location in New York State. In this example, when route and load plan 905 can be based on a multi-partition distance, the route and load plan can be amended to include delivery stops to one of several CP locations in Kansas City, Wisconsin, and/or Ohio.

In several embodiments, FIG. 5 alternately and optionally can include an activity 530 of identifying shipments excluded from the multiple spatial partitions. In some embodiments, some of the reasons that shipments are excluded from multiple spatial partitions can include shipments with shipping constraints or rules such as (i) no routes allowed to a CP or (ii) not covered by a base region of a CP, thus complement partitions can be created to build loads for such shipments.

In some embodiments, grouping the shipments so that each group covers a number of alternate facilities. In various embodiments, creating an alternate spatial partition for each group that covers a number of alternate facilities, such as DC center.

In some embodiments, another exception for shipments outside of the coverage of the multiple spatial partitions and/or CP center partitions can include adding complement DC partitions. In some embodiments, grouping the shipments so that each group covers a number of alternate facilities. In various embodiments, creating an alternate spatial partition for each group that covers a number of alternate facilities, such as a DC center.

Returning to FIG. 3, communication system 311 can at least partially perform an activity 505 (FIG. 5) obtaining a distribution of transit miles for inbound loads located within a distance of each facility of multiple facilities.

In many embodiments, partitioning system 312 can at least partially perform an activity creating, using a partition engine, multiple spatial partitions within the distance of each facility of the multiple facilities and/or activity 515 (FIG. 5) determining, using the partition engine, a multi-partition distance by combining multiple spatial partitions with overlapping distances.

In some embodiments, consolidation system 313 can at least partially perform activity 520 (FIG. 5) determining shipment consolidation options for the inbound loads within the multi-partition distance of the multiple facilities.

In several embodiments, load planning system 314 can at least partially perform activity 525 (FIG. 5) generating a transit plan corresponding to the inbound loads located within the multi-partition distance, based on the shipment consolidation options and/or activity 530 (FIG. 5) of identifying shipments excluded from the multiple spatial partitions.

In several embodiments, web server 320 can include a webpage system 321. Webpage system 321 can at least partially perform sending instructions to user computers (e.g., 350-351 (FIG. 3)) based on information received from communication system 311.

In many embodiments, the techniques described herein can be used continuously at a scale that cannot be handled using manual techniques. For example, the number of daily and/or monthly shipments sent out be vendors and received at facilities can exceed approximately ten thousand and/or other suitable numbers approximately each day from a few hundred vendors located across the United States.

In a number of embodiments, the techniques described herein can solve a technical problem that arises only within the realm of computer networks, as determining whether to consolidate shipments based on a multi-partition distance does not exist outside the realm of computer networks. Moreover, the techniques described herein can solve a technical problem that cannot be solved outside the context of computer networks. Specifically, the techniques described herein cannot be used outside the context of computer networks, in view of a lack of data that is part of the techniques described herein would not exist.

Various embodiments can include a system including a processor and a non-transitory computer-readable media storing computing instructions that, when executed on the processor, cause the processor to perform certain operations. The operations can include obtaining a distribution of transit miles for inbound loads located within a distance of each facility of multiple facilities. The operations also can include creating, using a partition engine, multiple spatial partitions within the distance of each facility of the multiple facilities. The operations further can include determining, using the partition engine, a multi-partition distance by combining multiple spatial partitions with overlapping distances. The operations additionally can include determining shipment consolidation options for the inbound loads within the multi-partition distance of the multiple facilities. The operations also can include generating a transit plan corresponding to the inbound loads located within the multi-partition distance, based on the shipment consolidation options.

A number of embodiments can include a computer-implemented method. The method can include obtaining a distribution of transit miles for inbound loads located within a distance of each facility of multiple facilities. The method also can include creating, using a partition engine, multiple spatial partitions within the distance of each facility of the multiple facilities. The method further can include determining, using the partition engine, a multi-partition distance by combining multiple spatial partitions with overlapping distances. The method additionally can include determining shipment consolidation options for the inbound loads within the multi-partition distance of the multiple facilities. The method also can include generating a transit plan corresponding to the inbound loads located within the multi-partition distance, based on the shipment consolidation options.

Additional embodiments can include a non-transitory computer-readable media storing computing instructions that, when executed on a processor, cause the processor to perform certain operations. The operations can include obtaining a distribution of transit miles for inbound loads located within a distance of each facility of multiple facilities. The operations also can include creating, using a partition engine, multiple spatial partitions within the distance of each facility of the multiple facilities. The operations further can include determining, using the partition engine, a multi-partition distance by combining multiple spatial partitions with overlapping distances. The operations additionally can include determining shipment consolidation options for the inbound loads within the multi-partition distance of the multiple facilities. The operations also can include generating a transit plan corresponding to the inbound loads located within the multi-partition distance, based on the shipment consolidation options.

Although performing spatial partitioning of a cross-dock transportation network has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-9 may be modified, and that the foregoing discussion of certain of these embodiments does not necessarily represent a complete description of all possible embodiments. For example, one or more of the procedures, processes, or activities of FIGS. 4-5 may include different procedures, processes, and/or activities and be performed by many different modules, in many different orders, and/or one or more of the procedures, processes, or activities of FIGS. 4-5 may include one or more of the procedures, processes, or activities of another different one of FIGS. 4-5. Additional details regarding communication system 311, partitioning system 312, consolidation system 313, load planning system 314, webserver 320 and/or webpage system 321 (FIGS. 3 and 5) can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising a processor and a non-transitory computer-readable medium storing computing instructions that, when executed on the processor, cause the processor to perform operations comprising:
obtaining a distribution of transit miles for inbound loads located within a distance of each facility of multiple facilities;
creating, using a partition engine, multiple spatial partitions within the distance of each facility of the multiple facilities;
determining, using the partition engine, a multi-partition distance by combining multiple spatial partitions with overlapping distances;
determining shipment consolidation options for the inbound loads within the multi-partition distance of the multiple facilities; and
generating a transit plan corresponding to the inbound loads located within the multi-partition distance, based on the shipment consolidation options.

2. The system of claim 1, wherein obtaining the distribution of transit miles for the inbound loads is based on at least one of (i) vendor locations in proximity to facility locations or (ii) a list of states in which the facility locations are located.

3. The system of claim 1, wherein creating the multiple spatial partitions comprises:
identifying a base region for a facility of the multiple facilities.

4. The system of claim 3, wherein identifying the base region comprises:
determining an expandable radius of the base region to capture an area a target coverage percentage for the facility.

5. The system of claim 4, wherein the target coverage percentage is a percentage that is greater than or equal to a number of covered historical loads at the facility divided by a number of total historical loads for the facility.

6. The system of claim 5, wherein the covered historical loads comprise historical loads for which a vendor location is either (i) within the expandable radius of a first distance to the facility, or (ii) located in a list of states covered by the vendor location of the facility.

7. The system of claim 6, wherein, when the percentage is less than the target covered percentage, expanding the expandable radius of the first distance to the facility or adding another state to the list of states.

8. The system of claim 6, wherein determining the shipment consolidation options comprises:
adding a shipment to the inbound loads when a direct transit mileage from the vendor location to the facility exceeds a predetermined threshold.

9. The system of claim 1, wherein the operations further comprise:
identifying shipments excluded from the multiple spatial partitions.

10. The system of claim 9, wherein:
grouping the shipments so that each group covers a number of alternate facilities; and
creating an alternate spatial partition for each group that covers the number of alternate facilities.

11. A computer-implemented method comprising:
obtaining a distribution of transit miles for inbound loads located within a distance of each facility of multiple facilities;
creating, using a partition engine, multiple spatial partitions within the distance of each facility of the multiple facilities;
determining, using the partition engine, a multi-partition distance by combining multiple spatial partitions with overlapping distances;
determining shipment consolidation options for the inbound loads within the multi-partition distance of the multiple facilities; and
generating a transit plan corresponding to the inbound loads located within the multi-partition distance, based on the shipment consolidation options.

12. The computer-implemented method of claim 11, wherein obtaining the distribution of transit miles for the inbound loads is based on at least one of (i) vendor locations in proximity to facility locations or (ii) a list of states in which the facility locations are located.

13. The computer-implemented method of claim 11, wherein creating the multiple spatial partitions comprises:
identifying a base region for a facility of the multiple facilities.

14. The computer-implemented method of claim 13, wherein identifying the base region comprises:
determining an expandable radius of the base region to capture an area a target coverage percentage for the facility.

15. The computer-implemented method of claim 14, wherein the target coverage percentage is a percentage that is greater than or equal to a number of covered historical loads at the facility divided by a number of total historical loads for the facility.

16. The computer-implemented method of claim 15, wherein the covered historical loads comprise historical loads for which a vendor location is either (i) within the expandable radius of a first distance to the facility, or (ii) located in a list of states covered by the vendor location of the facility.

17. The computer-implemented method of claim 16, wherein, when the percentage is less than the target covered percentage, expanding the expandable radius of the first distance to the facility or adding another state to the list of states.

18. The computer-implemented method of claim 16, wherein determining the shipment consolidation options comprises:
adding a shipment to the inbound loads when a direct transit mileage from the vendor location to the facility exceeds a predetermined threshold.

19. A non-transitory computer-readable medium storing computing instructions that, when executed on a processor, cause the processor to perform operations comprising:
obtaining a distribution of transit miles for inbound loads located within a distance of each facility of multiple facilities;
creating, using a partition engine, multiple spatial partitions within the distance of each facility of the multiple facilities;
determining, using the partition engine, a multi-partition distance by combining multiple spatial partitions with overlapping distances;
determining shipment consolidation options for the inbound loads within the multi-partition distance of the multiple facilities; and
generating a transit plan corresponding to the inbound loads located within the multi-partition distance, based on the shipment consolidation options.

20. The non-transitory computer-readable medium of claim 19, wherein obtaining the distribution of transit miles for the inbound loads is based on at least one of (i) vendor locations in proximity to facility locations or (ii) a list of states in which the facility locations are located.
